(19) United States
(12) Patent Application Publication
(10) Pub. No.: US 2008/0059967 A1
(43) Pub. Date: Mar. 6, 2008

(54) WORKFLOW MANAGEMENT SYSTEM, WORKFLOW MANAGEMENT METHOD, WORKFLOW MANAGEMENT PROGRAM, AND RECORDING MEDIUM

(76) Inventors: Yoshiro MATSUI, Saitama (JP); Michael Niemann, Darmstadt (DE); Harald Holz, Kaiserslautern (DE); Oleg Rostanin, Kaiserslautern (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/842,572

(22) Filed: Aug. 21, 2007

(30) Foreign Application Priority Data
Aug. 31, 2006 (JP) 2006-236729

(51) Int. Cl. G06F 9/46

(52) U.S. Cl. 718/102

(57) ABSTRACT

A workflow management system for managing a workflow constituted of plural hierarchically segment tasks is disclosed. The workflow management system includes a storage unit that stores task information; a calculation unit that acquires the task information from the storage unit and calculates a critical path of the workflow from information on structures of the plural tasks, dependence between the plural tasks, statuses of the plural tasks, and schedules of the plural tasks contained in the task information; and a display control unit that causes the critical path calculated by the calculation unit to be displayed on a screen.

### BACKGROUND OF THE INVENTION

1. Field of the Invention

The present invention relates generally to workflow management systems, workflow management methods, workflow management programs, and recording media and, in particular, to a workflow management system for managing a workflow constituted of plural hierarchically segment tasks, a workflow management method, a workflow management program, and a recording medium.

2. Description of the Related Art

In recent years and continuing to the present, a project management tool such as MS Project™ based on WBS (Work Breakdown Structure) has been known.

The term “project” as used herein refers to an activity in which people act as a team for a fixed period of time to achieve a certain goal, while the term “WBS” refers to an operations exploded diagram or the like and represents a method by which all the operations included in the project are picked out as tasks to clarify their contents, and which constitutes the basis of the work plan.

The description here of MS Project™ is made as an example of the conventional project management tools. With MS Project™, for example, the progress of a project is managed by a process (workflow), while in the process (workflow), the progress of a project is managed by tasks.

In MS Project™ in which the progress of a project is managed by tasks, scheduled start/end times and dates, estimated man-hours, actual start/end times and dates of respective tasks are used, thereby managing the progress and a resource person in charge of the project.

One main function of MS Project™ is the hierarchization of tasks by WBS. Note, however, that there is no parent-child relationship between tasks of MS Project™. The parent task is insubstantial and serves only as a task including other tasks.

Another main function of MS Project™ is the management by a precedent task of dependence between tasks. Another main function is scheduling and planning management by the period, start date, end date, and a resource person in charge of tasks.

Another main function is progress management via input of operation track records. Another main function is project management (that recognizes a task with a zero number of surplus days as a critical task and automatically calculates a critical path) by a critical path. Still another main function is the visualization of processes by a Gantt chart and a PERT chart.

Note that the applicant has been unable to find any publication of related art documents associated with the present invention prior to the filing this application, and this is why no information on related art documents is disclosed herein.

Conventional project management tools make it possible to manage processes by strictly managing task information such as the period, start date, end date, precedent task, and a resource person in charge of tasks. From a practical standpoint, however, the addition of a task or the change of a resource person in charge during the execution of a project can possibly take place. The attempt to deal with these matters could result in various unintended contradictions, thereby making it difficult to successfully use the project management tools.

Accordingly, the present applicant has proposed a new project management tool (workflow management system) to enable making a flexible change to a project and has applied for a patent (see, e.g., JP-A-2006-3497 and JP-A-2006-3500).

With the workflow management system as described in JP-A-2006-3497 and JP-A-2006-3500, the use of AKW (Agile Knowledge Workflow) technology makes it easier to change tasks. In other words, the workflow management system as described in JP-A-2006-3497 and JP-A-2006-3500 allows a project to be changed frequently.

However, since the new workflow management system allows a project to be changed frequently, there arises a problem that the progress management of a project becomes difficult. Specifically, it becomes difficult for a manager to find a critical path during the progress management of a project and to accurately and promptly detect a delay risk from the critical path.

The present invention is made in view of the above points and may provide a workflow management system, a workflow management method, a workflow management program, and a recording medium capable of accurately and easily managing the progress of a project.

### SUMMARY OF THE INVENTION

In order to solve the above problems, according to an aspect of the present invention, there is provided a workflow management system for managing a workflow constituted of plural hierarchically segment tasks. The workflow management system comprises a storage unit that stores task information; a calculation unit that acquires the task information from the storage unit and calculates a critical path of the workflow from information on structures of the plural tasks, dependence between the plural tasks, statuses of the plural tasks, and schedules of the plural tasks contained in the task information; and a display control unit that causes the critical path calculated by the calculation unit to be displayed on a screen.

Note that the application of any combination of the expressions or constituents of the present invention to a method, an apparatus, a system, a computer program, a recording medium, a data structure, or the like is also effective as the embodiments of the present invention.

According to the preferred embodiments of the present invention, it is possible to provide a workflow management system, a workflow management method, a workflow management program, and a recording medium capable of accurately and easily managing the progress of a project.

### BRIEF DESCRIPTION OF THE DRAWINGS

FIG. 1 is a system configuration diagram of an embodiment of a workflow management system according to an embodiment of the present invention;

FIG. 2 is a sequence diagram showing an example of critical path display processing in the workflow management system;

FIG. 3 is an example of a task table;

FIG. 4 is an example of a task sequence table;

FIG. 5 is a sequence diagram showing an example of the addition processing of a task in the workflow management system;

FIG. 6 is a schematic representation showing an example of the hierarchization of tasks with WBS;

FIG. 7 is a flowchart showing an example of processing in which the scheduled end date of a task sequence is derived;

FIG. 8 is a flowchart showing an example of processing in which the scheduled end date of a parent task having child tasks is derived;

FIG. 9 is a schematic representation showing an example of a Gantt chart displayed by a browser before the scheduled start date (at the planning phase) of a project;

FIG. 10 is a schematic representation showing an example of a Gantt chart displayed by a browser after the scheduled start date of a project;

FIG. 11 is a schematic representation showing another example of a Gantt chart displayed by a browser after the scheduled start date of a project; and

FIG. 12 is a schematic representation showing another example of a Gantt chart displayed by a browser after the scheduled start date of a project.

### DETAILED DESCRIPTION OF THE PREFERRED EMBODIMENTS

Next, referring to the accompanying drawings, a description is made of the best mode for carrying out the present invention based on the embodiments below.

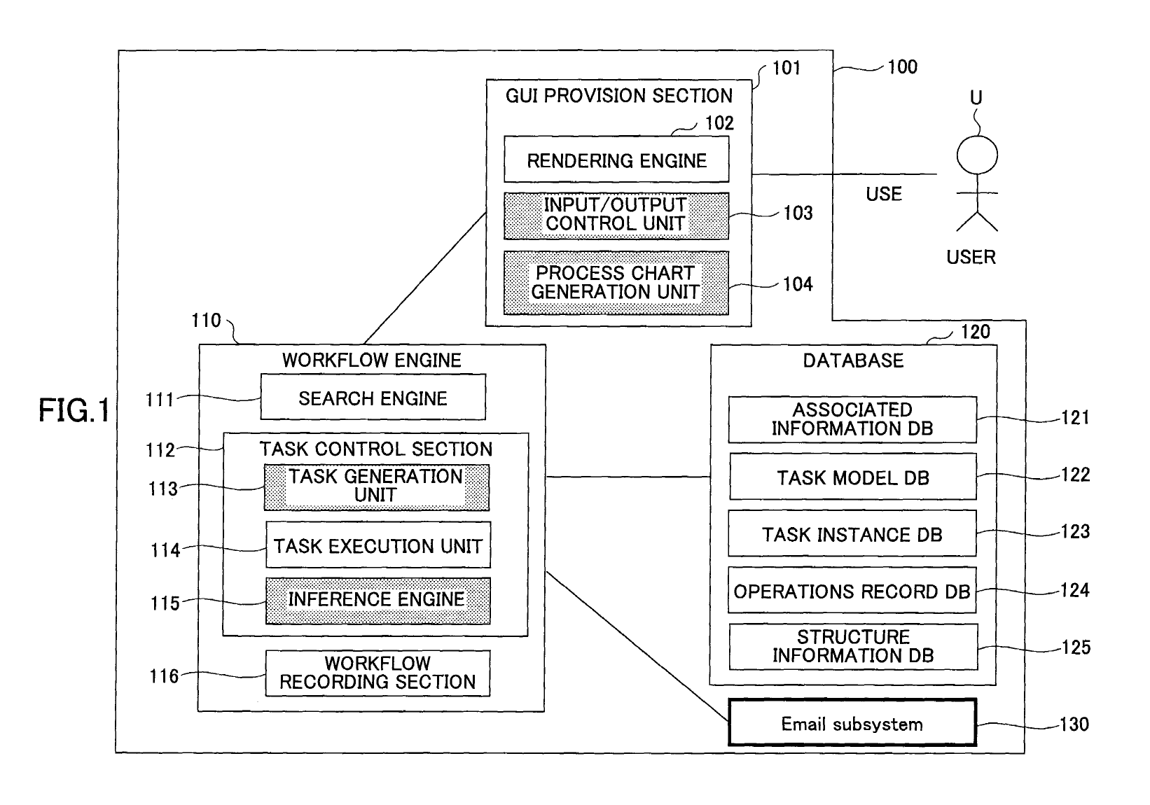

FIG. 1 is a system configuration diagram of a workflow management system according to an embodiment of the present invention. The workflow management system 100 of FIG. 1 includes a GUI provision section 101, a workflow engine 110, a database 120, and an Email subsystem 130.

The GUI provision section 101 provides a GUI (Graphical User Interface) with a user terminal (not shown) operated by the user who uses the workflow management system 100.

The workflow engine 110 dynamically generates and executes a workflow model by recycling it from an existing task model and/or task instance. The database 120 systematically manages various information items. The Email subsystem 130 executes various processing on Email.

The GUI provision section 101 includes a rendering engine 102, an input/output control unit 103, and a process chart generation unit 104. The rendering engine 102 plots a display screen. The input/output control unit 103 exchanges information with the user terminal operated by the user U. The process chart generation unit 104 generates a process chart.

The workflow engine 110 is provided with a search engine 111, a task control section 112, and a workflow recording section 116. The search engine 111 executes various searches with respect to the database 120. The task control section 112 controls tasks constituting a workflow. The workflow recording section 116 refers to the database 120 and monitors the operations of the workflow management system 100 with the user terminal operated by the user U, to thereby record the operation records of a workflow on the operations record DB (Database) 124 as is described below.

The task control section 112 includes a task generation unit 113, a task execution unit 114, and an inference engine 115. The task generation unit 113 generates tasks. The task execution unit 114 executes generated tasks. The inference engine 115 infers a present task of the user U based on information of the operations record DB 124 and searches for associated information from the database 120.

The database 120 includes an associated information DB (Database) 121, a task model DB (Database) 122, a task instance DB (Database) 123, an operations record DB (Database) 124, and a structure information DB (Database) 125. The associated information DB 121 stores associated information items referred to when a workflow is executed. The task model DB 122 stores task models previously abstracted by a manager or the like.

The task instance DB 123 stores past task instances. The operations record DB 124 stores operation records of a workflow. The structure information DB 125 stores structural information items of a company or the like. Note that the task model DB 122 and the task instance DB 123 link the information items registered in the associated information DB 121.

As a general operation, the user U operates the workflow engine 110 through the input/output control unit 103 of the GUI provision section 101 with the user terminal. Thereby, the user U, for example, generates and executes a workflow, generates a workflow model, registers associated information, and links them with a workflow instance and the workflow model.

In generating a workflow, the search engine 111 of the workflow engine 110 executes various searches with respect to the database 120. Furthermore, the task control section 112 of the workflow engine 110 controls tasks based on the instructions from the user U or the like using the task model DB 122 and the task instance DB 123.

The task generation unit 113 of the task control section 112, for example, generates tasks and links information together based on the information of the database 120 in accordance with the instructions from the user U. The task execution unit 114 updates actual task information using the information of the task instance DB 123 in accordance with the instructions from the user U. The execution of tasks is, in other words, the update of task information as viewed from the workflow management system.

The inference engine 115 infers the present task of the user U based on the information of the operations record DB 124 and searches for associated information in the database 120. The workflow recording section 116 monitors the operations of the user U and the workflow management system 100 and stores the operation records of a workflow in the operations record DB 124.

Note that the workflow management system 100 is executed, for example, by a PC (Personal Computer). Unless otherwise specified, the operation processing of respective embodiments below is executed and processed by a CPU in such a manner as to use as a work area a main memory, such as a RAM, in accordance with the programs stored in a ROM, a hard disk device, or the like.

Below, a description is made of first through third embodiments capable of accurately and easily managing the progress of a project in the workflow management system 100 of FIG. 1. The workflow management system 100 of the embodiment of the present invention can accurately and easily manage the progress of a project while allowing frequent changes of the project.

First, the workflow management system 100 of the embodiments of the present invention makes it possible for any task to have a child task with WBS. Furthermore, the workflow management system 100 of the embodiments of the present invention allows a parent task to be substantial.

Furthermore, the workflow management system 100 of the embodiments of the present invention eliminates the temporal dependence between a parent task and a child task and allows each of the parent task and the child task to have any start date, end date, or period. However, in the workflow management system 100 of the embodiments of the present invention, a parent task starts before a child task and ends after it. Furthermore, the workflow management system 100 of the embodiments of the present invention can execute a parent task and a child task separately or concurrently.

Furthermore, the workflow management system 100 of the embodiments of the present invention maintains the order relationship between tasks apart from the parent-child relationship between tasks with WBS. This order relationship is similar to a precedent task of MS Project™ as described above.

Furthermore, the workflow management system 100 of the embodiments of the present invention allows the user to set the progress of respective tasks based on the number of remaining days or the proportion of the tasks. Furthermore, the workflow management system 100 of the embodiments of the present invention finds the critical path of a project as is described below based on the order relationship between tasks and the period of tasks. It is possible for the user to manage the progress of a project by referring to a critical path.

Furthermore, the workflow management system 100 of the embodiments of the present invention displays in a list tasks included in a critical path as critical tasks and manages the progress of the critical tasks. Furthermore, the workflow management system 100 of the embodiments of the present invention calculates the progress of critical tasks based on the progress of sub-tasks if the critical tasks include the sub-tasks.

Furthermore, the workflow management system 100 of the embodiments of the present invention can inform the user of an increased delay risk on the display screen of a user terminal or by email if the delay risk is detected in a critical path.

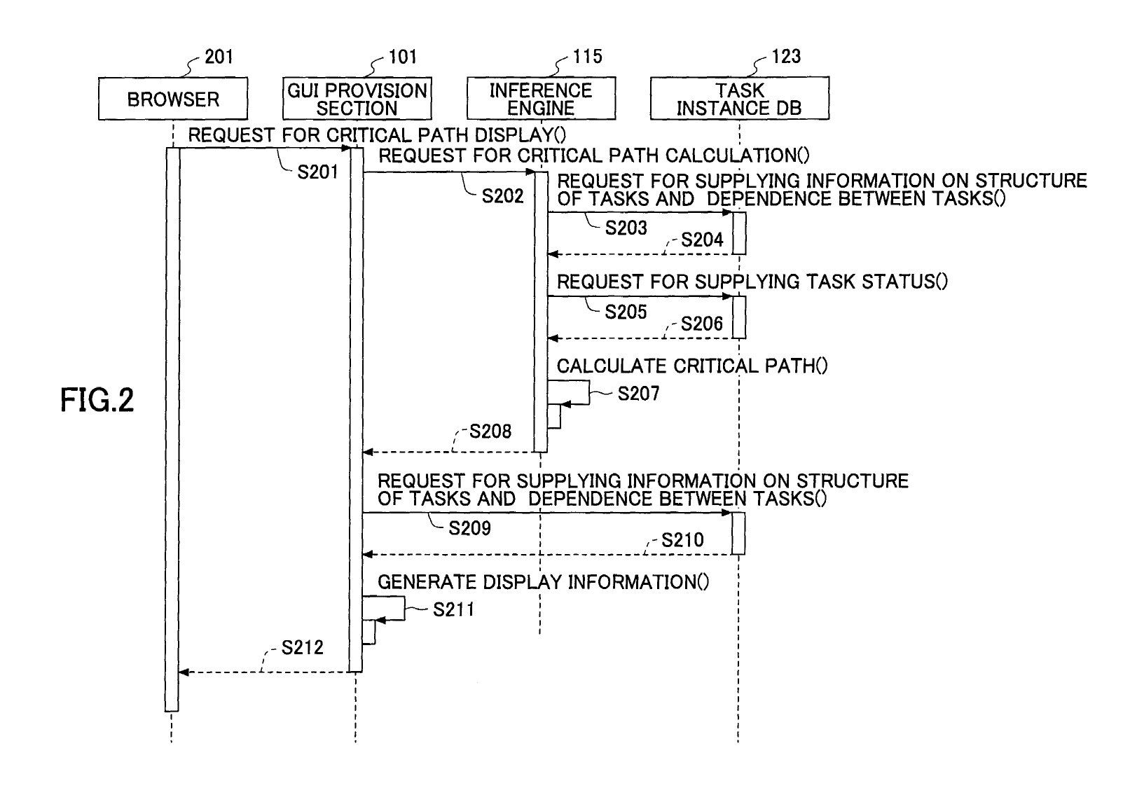

FIG. 2 is a sequence diagram showing an example of critical path display processing in the workflow management system. Note that a browser 201 of FIG. 2 is mounted on a user terminal. The process proceeds to step S201 where the browser 201 mounted on the user terminal requests the GUI provision section 101 of the workflow management system 100 to display a critical path based on the request from the user.

The process proceeds to step S202 where the GUI provision section 101 designates the project selected by the user and requests the inference engine 115 to calculate a critical path based on the critical path display request. The process proceeds to step S203 where the inference engine 115 requests the task instance DB 123 to supply information on the structure of tasks and the dependence between tasks necessary for calculating a critical path based on the critical path calculation request.

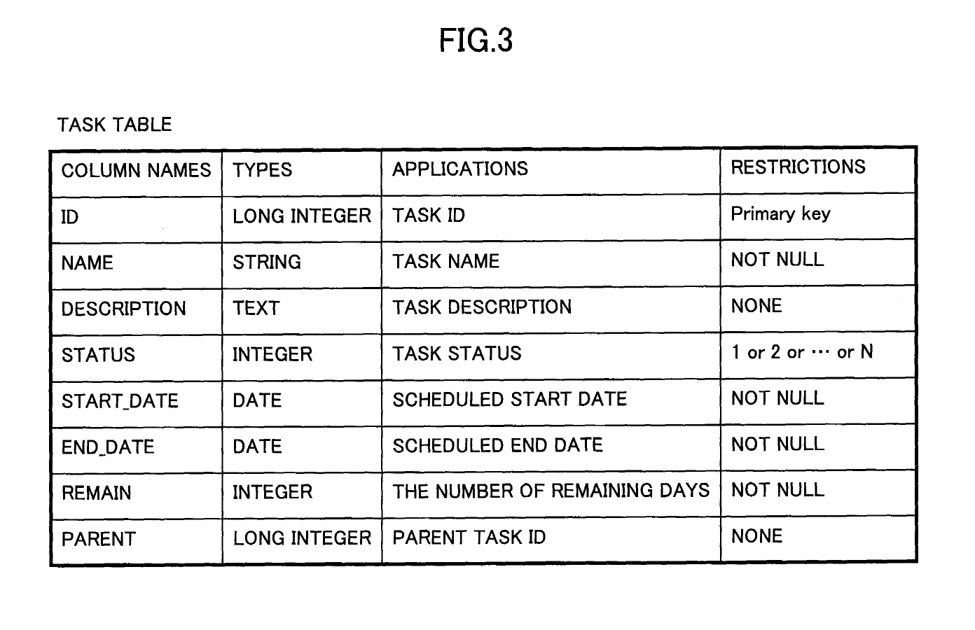

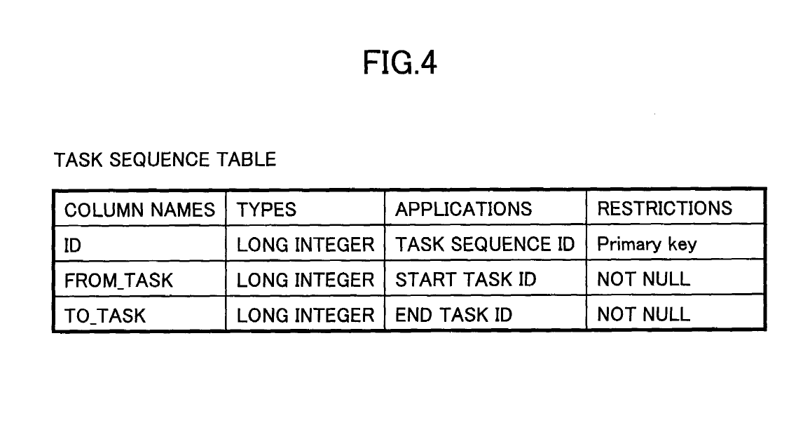

The task instance DB 123 stores, for example, the information on the structure of tasks and the dependence between tasks in a table schema as shown in FIGS. 3 and 4. FIG. 3 is an example of a task table. FIG. 4 is an example of a task sequence table.

The task table of FIG. 3 is composed of a task ID, a task name, a task description, a task status, a scheduled start date, a scheduled end date, the number of remaining days, and a parent task ID. The task sequence table of FIG. 4 is composed of a task sequence ID, a start task ID, and an end task ID.

For example, the information on the structure of tasks and the dependence between tasks can be acquired from the task table of FIG. 3 and the task sequence table of FIG. 4. The process proceeds to step S204 where the inference engine 115 receives the information on the structure of tasks and the dependence between tasks from the task instance DB 123.

The process proceeds to step S205 where the inference engine 115 then requests the task instance DB 123 to supply task status information necessary for calculating a critical path. For example, the task status information can be acquired from the task table of FIG. 3. The process proceeds to step S206 where the inference engine 115 receives the task status information from the task instance DB 123.

The process proceeds to step S207 where the inference engine 115 calculates a critical path as described below. The process proceeds to step S208 where the inference engine 115 transmits the calculated result of a critical path to the GUI provision section 101.

The process proceeds to step S209 where the GUI provision section 101 requests the task instance DB 123 to supply information on the structure of tasks and the dependence between tasks necessary for generating display information. The process proceeds to step S210 where the GUI provision section 101 receives the information on the structure of tasks and the dependence between tasks from the task instance DB 123.

The process proceeds to step S211 where the GUI provision section 101 generates the display information based on the calculated result of a critical path and the information on the structure of tasks and the dependence between tasks. The process proceeds to step S212 where the GUI provision section 101 transmits the generated display information to the browser 201 and causes the browser 201 to display the screen on which the critical path is displayed as described below.

Note that the workflow management system 100 of the embodiments of the present invention recalculates a critical path if a task is added or divided or a task is delayed or shortened. A description is now made of the addition processing of a task as an example.

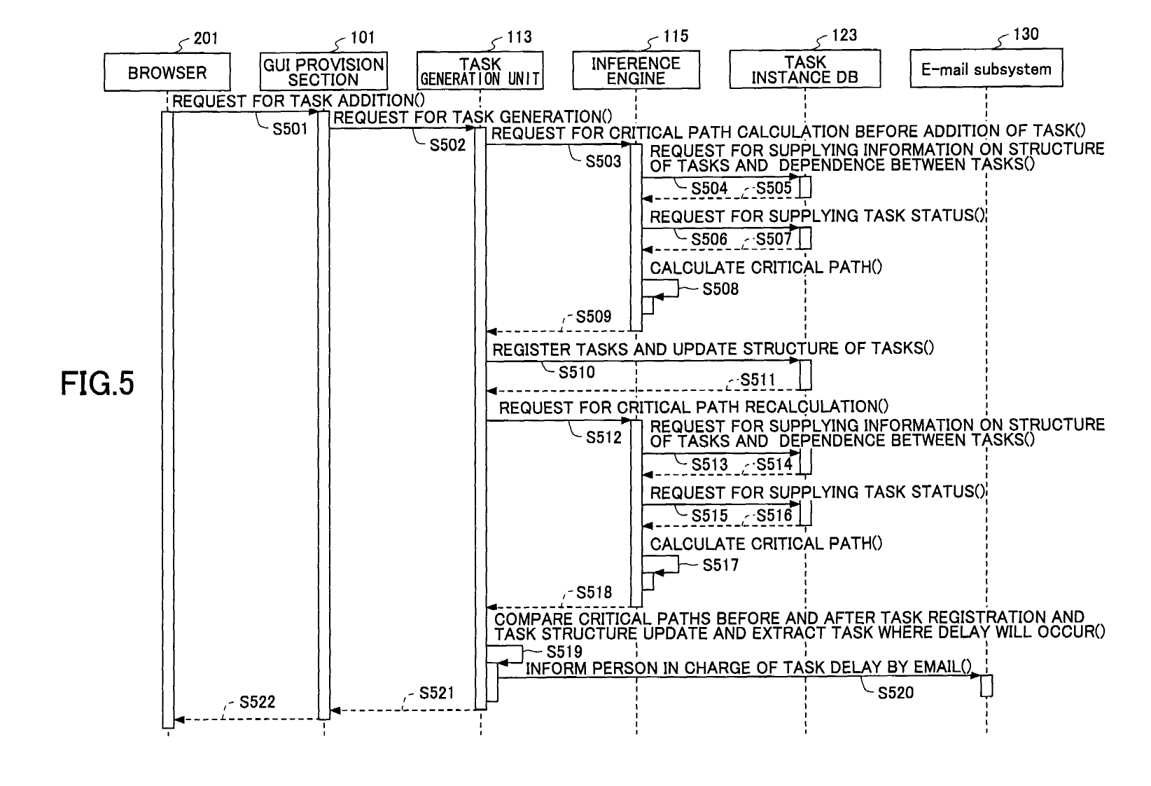

FIG. 5 is a sequence diagram showing an example of the addition processing of a task in the workflow management system. Note that the browser 201 of FIG. 2 is mounted on a user terminal.

The process proceeds to step S501 where the browser 201 mounted on the user terminal designates the project selected by the user based on the request from the user and requests the GUI provision section 101 of the workflow management system 100 to add the task.

The process proceeds to step S502 where the GUI provision section 101 requests the task generation unit 113 to generate the task based on the task addition request. The process proceeds to step S503 where the task generation unit 113 requests the inference engine 115 to calculate a critical path before the addition of the task based on the task generation request. The process proceeds to step S504 where the inference engine 115 requests the task instance DB 123 to supply information on the structure of tasks and the dependence between tasks necessary for calculating a critical path based on the critical path calculation request before the addition of the task. The process proceeds to step S505 where the inference engine 115 receives the information on the structure of tasks and the dependence between tasks from the task instance DB 123.

The process proceeds to step S506 where the inference engine 115 requests the task instance DB 123 to supply task status information necessary for calculating a critical path. The process proceeds to step S507 where the inference engine 115 receives the task status information from the task instance DB 123.

The process proceeds to step S508 where the inference engine 115 calculates a critical path as described below. The process proceeds to step S509 where the inference engine 115 transmits the calculated result of a critical path to the task generation unit 113.

Upon receipt of the calculated result of a critical path before the addition of the task, the task generation unit 113 proceeds to step S510 to request the task instance DB 123 to register the task and update the structure of the tasks. Then, the process proceeds to step S511 where the task generation unit 113 receives the results of the task registration and task structure update from the task instance DB 123.

The process proceeds to step S512 where the task generation unit 113 requests the inference engine 115 to calculate a critical path after the addition of the task. The process proceeds to step S513 where the inference engine 115 requests the task instance DB 123 to supply information on the structure of tasks and the dependence between tasks necessary for calculating a critical path based on the critical path calculation request after the addition of the task. The inference engine 115 proceeds to step S514 to receive the information on the structure of tasks and the dependence between tasks from the task instance DB 123.

The process proceeds to step S515 where the inference engine 115 requests the task instance DB 123 to supply task status information necessary for calculating a critical path. The process proceeds to step S516 where the inference engine 115 receives the task status information from the task instance DB 123.

The process proceeds to step S517 where the inference engine 115 calculates a critical path as described below. The process proceeds to step S518 where the inference engine 115 transmits the calculated result of a critical path to the task generation unit 113.

Upon receipt of the calculated result of a critical path after the addition of the task, the task generation unit 113 proceeds to step S519 to compare the critical path before the addition of the task with that after the addition of the task and extracts the task where a delay will occur. The process proceeds to step S520 where the task generation unit 113 requests the Email subsystem 130 to inform the person in charge by email that the delay as extracted in step S519 will occur in his/her task. The Email subsystem 130 acquires necessary information from the database 120 and informs the person in charge by email that the delay will occur in his/her task.

Furthermore, the process proceeds to step S521 where the task generation unit 113 returns a response to the task generation request to the GUI provision section 101. Moreover, the process proceeds to step S522 where the GUI provision section 101 returns a response to the task addition request to the browser 201. Note that, in the sequence diagram of FIG. 5, the browser 201 may display the screen on which to display the critical path after the addition of the task and the task where a delay will occur, in the same manner as the sequence diagram of FIG. 2.

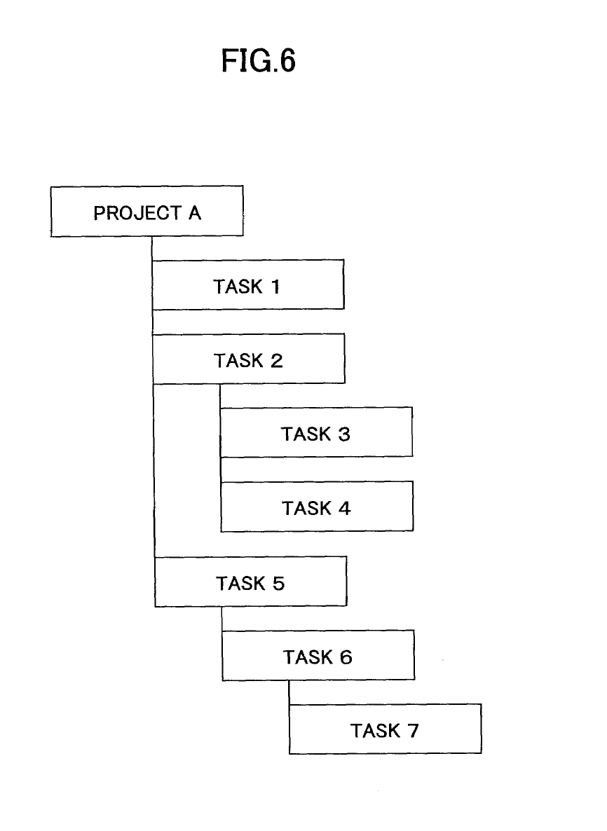

Next, a description is made of critical path calculation processing. FIG. 6 is a schematic representation showing an example of the hierarchization of tasks with WBS. “Project A” of FIG. 6 is composed of “task 1” through “task 7.”

“Task 3” and “task 4” are child tasks of “task 2.” “Task 6” is a child task of “task 5.” “Task 7” is a child task of “task 6.” In the case of “project A” of FIG. 6, the start and end dates of the respective tasks have the following restrictions.

For example, “task 2” has to start before “task 3” and “task 4” and end after them. “Task 5” has to start before “task 6” and “task 7” and end after them. “Task 6” has to start before “task 7” and end after it.

In “project A” of FIG. 6, the order relationship of “task 1”→“task 3”→“task 6” is established. In the present embodiments, this order relationship is called a task sequence. In “project A” of FIG. 6, a critical path is found according to the following procedure.

First, the inference engine 115 calculates a critical path as follows with respect to tasks and a task sequence in which an order relationship is defined. Note that such a relationship as “scheduled end date−scheduled start date>period” is established between a scheduled start date, a scheduled end date, and a period.

The inference engine 115 compares the scheduled end date of “task 1” with the scheduled start date of “task 3,” each constituting the task sequence. If the scheduled start date of “task 3” is set before the scheduled end date of “task 1,” the inference engine 115 changes the scheduled start date of “task 3” to the scheduled end date of “task 1.”

Then, the inference engine 115 compares the scheduled end date of “task 3” with the scheduled start date of “task 6,” each constituting the task sequence. If the scheduled start date of “task 6” is set before the scheduled end date of “task 3,” the inference engine 115 changes the scheduled start date of “task 6” to the scheduled end date of “task 3.”

Thus, the inference engine 115 changes the scheduled end date of the task sequence having the order relationship of “task 1”→“task 3”→“task 6” to the scheduled end date of “task 6.”

Then, the inference engine 115 compares the scheduled end date of “task 2” with the scheduled end date of “task 3,” both creating a parent-child relationship. If the scheduled end date of “task 2” is set before the scheduled end date of “task 3,” the inference engine 115 changes the scheduled end date of “task 2” to the scheduled end date of “task 3.”

The inference engine 115 compares the scheduled end date of “task 5” with the scheduled end date of “task 6,” both creating a parent-child relationship. If the scheduled end date of “task 5” is set before the scheduled end date of “task 6,” the inference engine 115 changes the scheduled end date of “task 5” to the scheduled end date of “task 6.”

The inference engine 115 compares the scheduled end dates of the task sequence, “task 2,” or “task 5” as calculated in the above procedure and defines as a critical path the task or the task sequence that is scheduled to end in the last place.

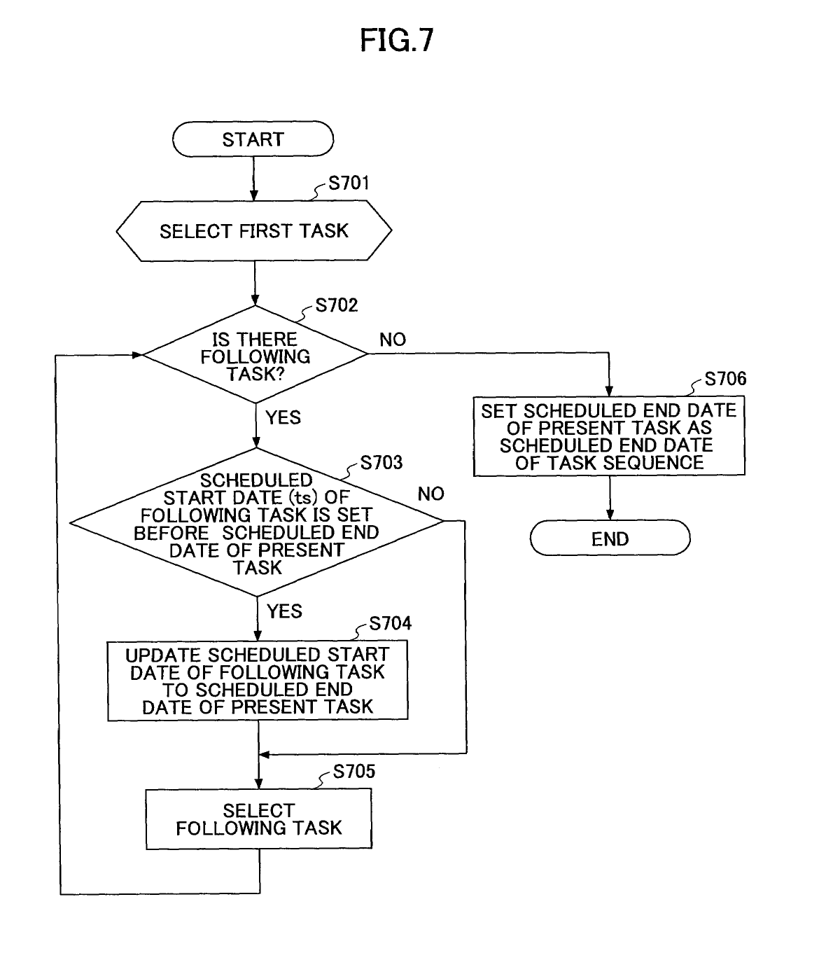

The scheduled end date of a task sequence is derived, for example, from the procedure as shown in the flowchart of FIG. 7. The process proceeds to step S701 where the inference engine 115 selects the first task of “task 1” from the task sequence having the order relationship of “task 1”→“task 3→“task 6” and defines it as a present task.

The process proceeds to step S702 where the inference engine 115 determines whether there is a task following the present task of “task 1” in the task sequence. Since there is a task of “task 3” following the present task of “task 1” in the task sequence, the inference engine 115 proceeds to step S703 to determine whether the scheduled start date (t2) of the following task is set before the scheduled end date (t1) of the present task.

If the scheduled start date (t2) of the following task of “task 3” is set before the scheduled end date (t1) of the present task of “task 1,” the inference engine 115 proceeds to step S704 to update the scheduled start date of the following tasks of “task 3” to the scheduled end date of the present task of “task 1,” and then proceeds to step S705. Note, however, that if the scheduled start date (t2) of the following task of “task 3” is not set before the scheduled end date (t1) of the present task of “task 1,” the inference engine 115 proceeds to step S705.

In step S705, the inference engine 115 selects the following task of “task 3” to be defined as a present task and returns to step S702. In step S702, the inference engine 115 determines whether there is a task following the present task of “task 3” in the task sequence. Since there is a task of “task 6” following the present task of “task 3” in the task sequence, the inference engine 115 proceeds to step S703 to determine whether the scheduled start date (t2) of the following task is set before the scheduled end date (t1) of the present task.

If the scheduled start date (t2) of the following task of “task 3” is set before the scheduled end date (t1) of the present task of “task 1,” the inference engine 115 proceeds to step S704 to update the scheduled start date of the following task of “task 6” to the scheduled end date of the present task of “task 3,” and then proceeds to step S705. Note, however, that if the scheduled start date (t2) of the following task of “task 6” is not set before the scheduled end date (t1) of the present task of “task 3,” the inference engine 115 proceeds to step S705.

In step S705, the inference engine 115 selects the following task of “task 6” to be defined as a present task and returns to step S702. In step S702, the inference engine 115 determines whether there is a task following the present task of “task 6” in the task sequence. Since there is no task following the present task of “task 6” in the task sequence, the inference engine 115 proceeds to step S706 to set the scheduled end date of the present task of “task 6” as the scheduled end date of the task sequence, and then ends the processing.

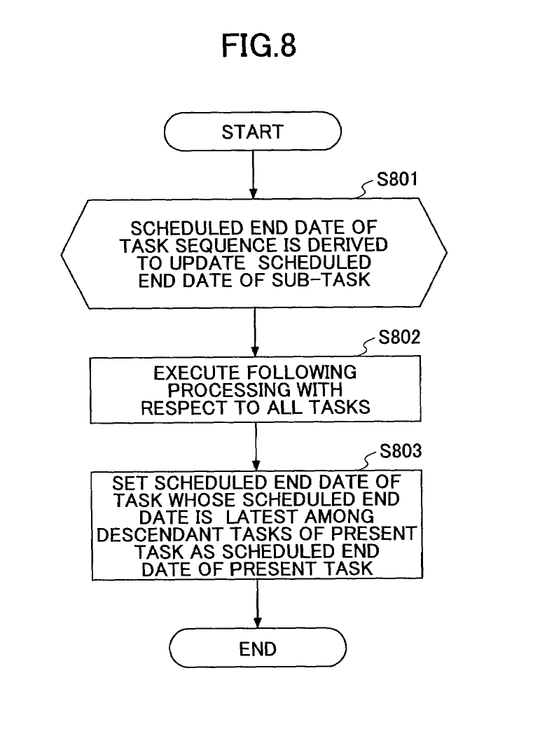

Furthermore, the scheduled end date of a parent task having child tasks is derived, for example, from the procedure as shown in the flowchart of FIG. 8. The process proceeds to step S801 where the inference engine 115 derives the scheduled end date of the task sequence having the order relationship of “task 1”→“task 3”→“task 6” to update the scheduled end date of a sub-task.

The process proceeds to step S802 where the inference engine 115 executes the processing of step S803 with respect to all the tasks constituting “project A.” In step S803, the scheduled end date of the task whose scheduled end date is the latest among descendant tasks of a present task is set as the scheduled end date of the present task.

Note that it is necessary to manage the progress of a parent task having child tasks in consideration of the following situation as the relationship between the parent task and the child tasks. First, the scheduled start date of a parent task has to be set before the scheduled start date of child tasks. Furthermore, the scheduled end date of a parent task has to be set after the scheduled end dates of child tasks. Furthermore, a parent task is substantial in task processing and has to be executed separately from child tasks. Moreover, child tasks have to be added arbitrarily.

For example, the progress of a parent task can be set as an average of the progress of the parent task and all the child tasks. Thus, the progress of all the tasks can be calculated. Furthermore, the reference of the progress of a critical task makes it possible to confirm the progress of a project in a critical path. If the number of remaining days of respective tasks is introduced, the progress of a task can be calculated by the formula as follows:

Progress of task=(period−the number of remaining days)/period (1)

For example, the browser 201 mounted on a user terminal can display Gantt charts of the first through fourth embodiments based on the critical path calculated as described above.

### First Embodiment

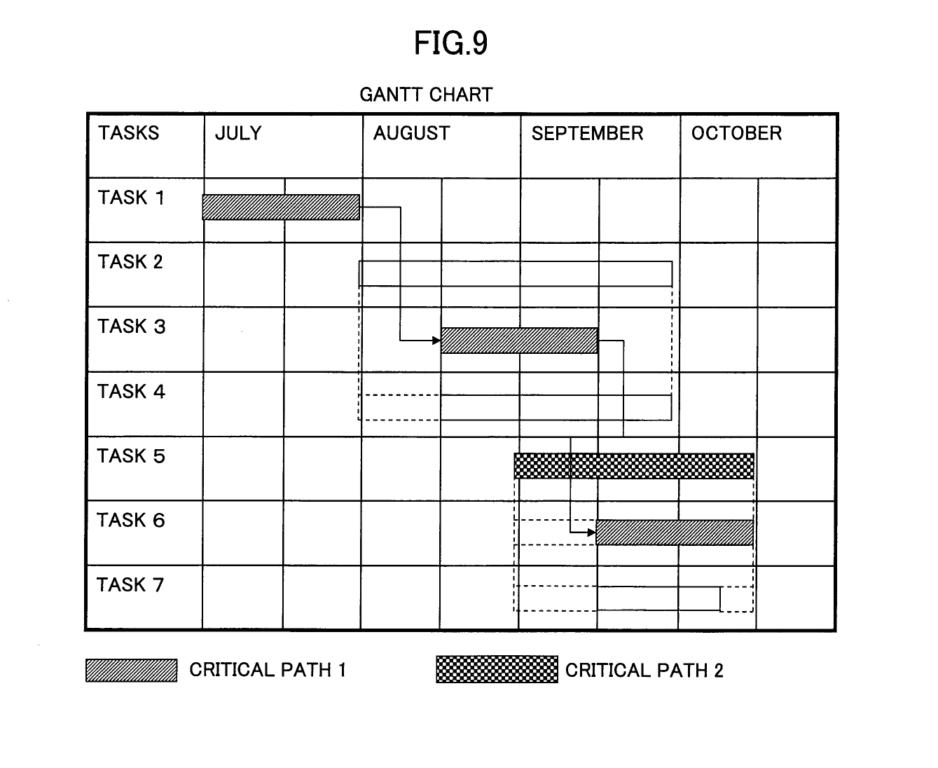

FIG. 9 is a schematic representation showing an example of a Gantt chart displayed by a browser before the scheduled start date (at the planning phase) of a project. The Gantt chart of FIG. 9 shows “critical path 1” and “critical path 2.” The “critical path 1” is, for example, a task sequence having the order relationship of “task 1”→“task 3”→“task 6.” Furthermore, the “critical path 2” is “task 5.” Note that the Gantt chart as shown in FIG. 9 or the like defines one month as 20 days (four weeks). Note, however, that the Gantt chart of FIG. 9 is generated, for example, by the use of the processing as represented in the sequence diagram of FIG. 2.

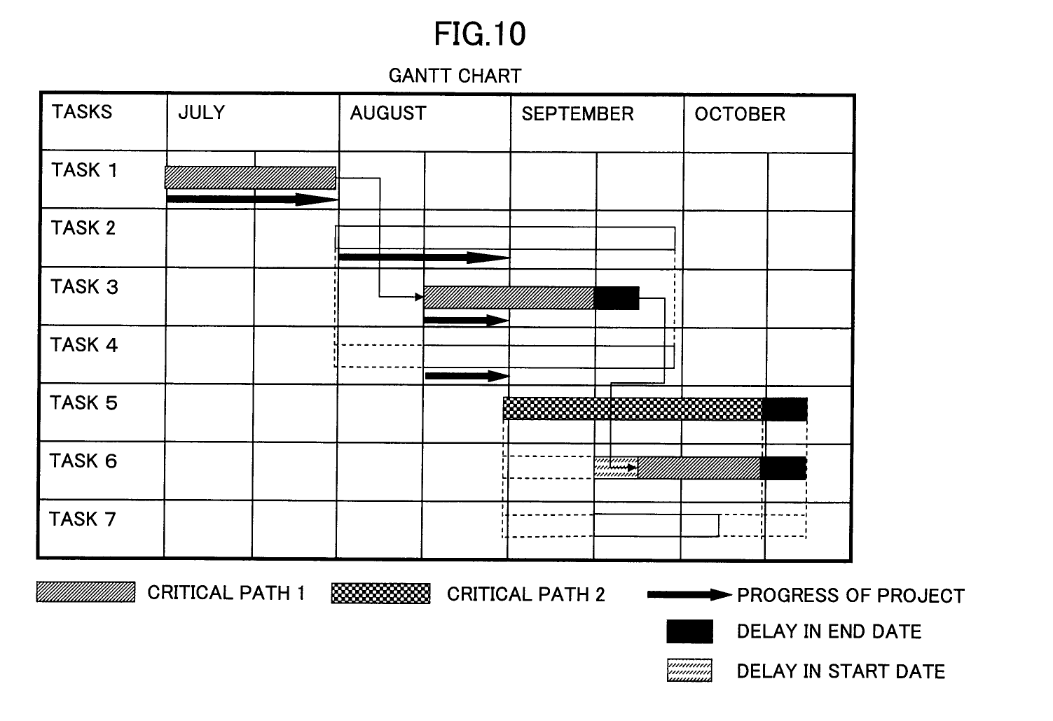

FIG. 10 is a schematic representation showing an example of a Gantt chart displayed by a browser after the scheduled start date of a project. The Gantt chart of FIG. 10 shows a case where a delay occurs in critical paths. Specifically, the number of remaining days of “task 3” is 15 days (three weeks) as of September 1.

In other words, a one-week delay occurs in “task 3” that is a critical task, thereby causing the end date of “task 3” to be delayed by one week. Furthermore, the one-week delay in the end date of “task 3” causes the start date and the end date of “task 6” to be delayed by one week. Moreover, the one-week delay in the end date of “task 6” causes the end date of “task 5” to be delayed by one week. As a result, the critical paths are caused to be delayed by one week.

If a delay occurs in critical paths, the workflow management system 100 can inform the manager of a project and the person in charge of respective tasks of the delay by using the browser 201 and email. Note that the Gantt chart of FIG. 10 is generated, for example, by the use of the processing as represented in the sequence diagram of FIG. 5.

### Second Embodiment

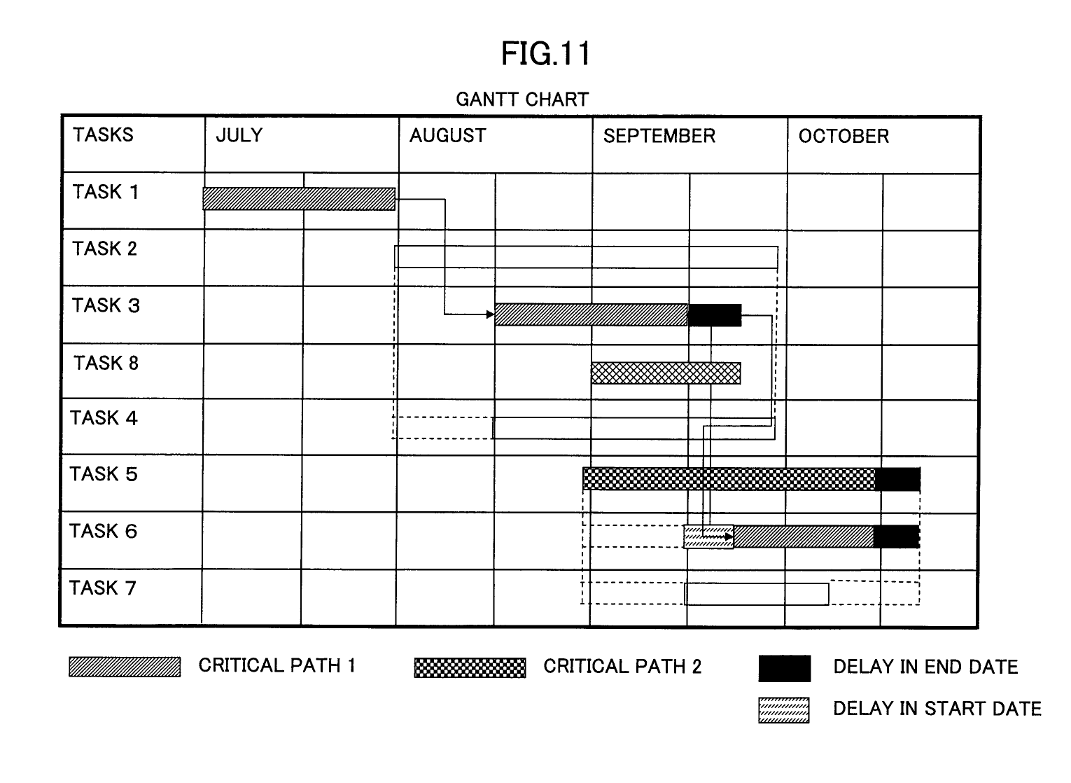

FIG. 11 is a schematic representation showing another example of a Gantt chart displayed by a browser after the scheduled start date of a project. The Gantt chart of FIG. 11 shows a case where “task 8” is added. Specifically, as of September 1, “task 8” having a period of three weeks is added as a sub-task of “task 3” that is a critical task.

In this case, since “task 3” that is the parent task of “task 8” cannot end before “task 8,” a one-week delay occurs in “task 3,” thereby causing the end date of “task 3” to be delayed by one week. Furthermore, the one-week delay in the end date of “task 3” causes the start date and the end date of “task 6” to be delayed by one week.

Moreover, the one-week delay in the end date of “task 6” causes the end date of “task 5” to be delayed by one week. As a result, the critical paths are caused to be delayed by one week.

If a delay occurs in critical paths, the workflow management system 100 can inform the manager of a project and the persons in charge of respective tasks of the delay by using the browser 201 and email. Note that the Gantt chart of FIG. 11 is generated, for example, by the use of the processing as represented in the sequence diagram of FIG. 5.

### Third Embodiment

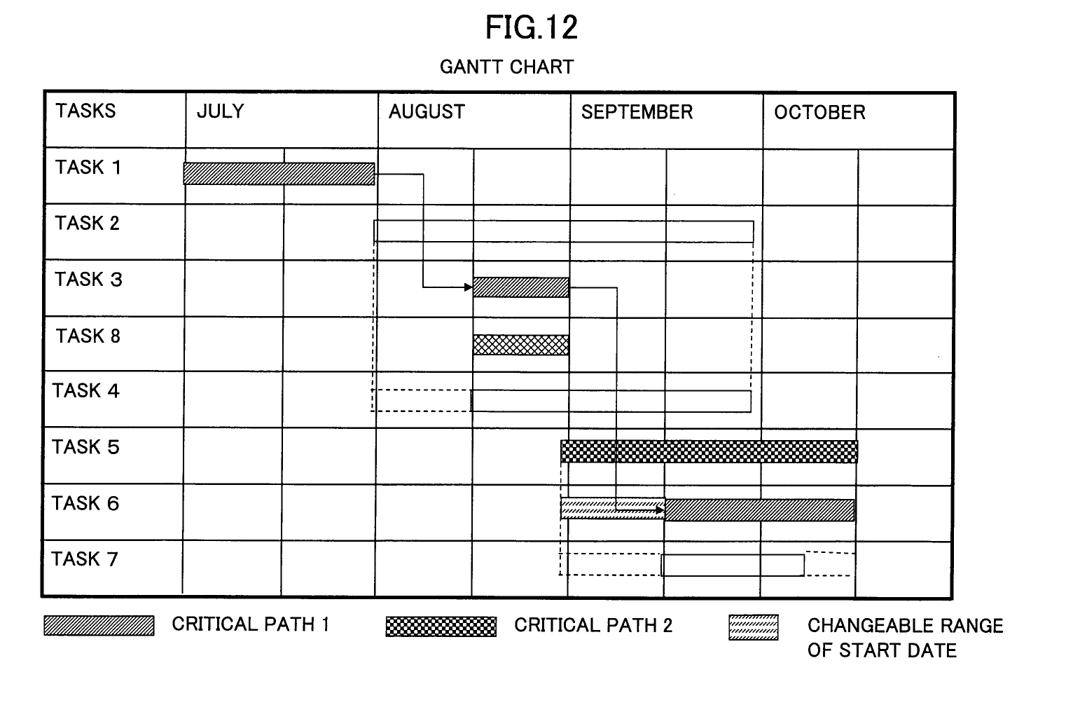

FIG. 12 is a schematic representation showing another example of a Gantt chart displayed by a browser after the scheduled start date of a project. The Gantt chart of FIG. 12 shows a case where part of “task 3” is divided as “task 8” to shorten its period.

Specifically, as of August 15, part of “task 3” that is a critical task is separated to be “task 8” having a period of two weeks and added as a sub-task of “task 3.” Thus, the period of “task 3” is shortened from four weeks to two weeks.

In this case, since “task 6” can start right after the end of “task 3,” it is possible to move up the start date of “task 6” by two weeks. The workflow management system 100 can inform the manager of a project and the person in charge of “task 6” by the browser 201 and email that it is possible to move up the schedule of “task 6” by two weeks, and prompt them to change the project.

Furthermore, when the schedule of “task 6” is changed to move up by two weeks, it is possible to inform the manager of the project and the person in charge of “task 5” of a changeable range of the schedule and to prompt them to change the project.

Accordingly, the task sequence having the order relationship of “task 1”→“task 3”→“task 6 is no longer a critical path. Only “task 5” serves as a critical path. The workflow management system 100 can inform the manager of the project and the person in charge of “task 5” to that effect.

### Summary of First Through Third Embodiments

The workflow management system 100 of the embodiments of the present invention can easily break down any tasks during the execution of a project. Furthermore, there sometimes occurs a case in which the breakdown of tasks disagrees with the order relationship between the tasks in actual operations, but the workflow management system 100 of the embodiments of the present invention can respond to such a case. Furthermore, the workflow management system 100 of the embodiments of the present invention can manage the progress of tasks.

Furthermore, the workflow management system 100 of the embodiments of the present invention presents an object to be especially managed in the progress of a project, thereby making it possible to properly manage the project without being concerned about unimportant details. Furthermore, plural critical tasks are regarded as a series of critical paths based on the order relationship between tasks, thereby making it possible to easily confirm the progress of a project even in a complicated situation.

Furthermore, the workflow management system 100 of the embodiments of the present invention can easily find a problem on the progress of a project in combination with the progress management of critical tasks. Moreover, the workflow management system 100 of the embodiments of the present invention automatically calculates a critical path every time a task is added, thereby making it possible to consistently manage the progress of the tasks based on the status of the latest task.

Thus, the workflow management system 100 of the embodiments of the present invention can detect the risk to the progress of an entire project in real time and present it to the user not only when the progress of a critical path is simply delayed, but also when a task is added.

The present invention is not limited to the embodiments as specifically described above, but various modifications and changes may be made without departing from the scope of the claims.

The present application is based on Japanese Priority Patent Application No. 2006-236729, filed on Aug. 31, 2006, the entire contents of which are hereby incorporated by reference.

What is claimed is:

1. A workflow management system for managing a workflow constituted of plural hierarchically segment tasks, comprising:
a storage unit that stores task information;
a calculation unit that acquires the task information from the storage unit and calculates a critical path of the workflow from information on structures of the plural tasks, dependence between the plural tasks, statuses of the plural tasks, and schedules of the plural tasks contained in the task information; and
a display control unit that causes the critical path calculated by the calculation unit to be displayed on a screen.

2. The workflow management system according to claim 1, wherein
the calculation unit manages tasks included in the critical path as critical tasks and calculates progress of the workflow based on progress of the critical tasks.

3. The workflow management system according to claim 1, wherein,
when a delay is detected in progress of the workflow, the display control unit causes the detection of the delay to be displayed on the screen.

4. The workflow management system according to claim 1, further comprising:
a transmission unit that, when the calculation unit detects a delay in progress of the workflow, transmits the detection of the delay to a user terminal.

5. The workflow management system according to claim 1, wherein
the dependence between the plural tasks represents an order relationship between respective tasks.

6. The workflow management system according to claim 1, further comprising:
a registration unit that registers in the storage unit the information on the structures of the plural tasks, the dependence between the plural tasks, the statuses of the plural tasks, and the schedules of the plural tasks; wherein
the calculation unit recalculates the critical path when the information on the structures of the plural tasks, the dependence between the plural tasks, the statuses of the plural tasks, and the schedules of the plural tasks stored in the storage unit are changed.

7. A workflow management method for managing a workflow constituted of plural hierarchically segment tasks, comprising:
an acquisition step of acquiring task information;
a calculation step of calculating a critical path of the workflow from information on structures of the plural tasks, dependence between the plural tasks, statuses of the plural tasks, and schedules of the plural tasks contained the task information; and
a display control step of causing the critical path calculated in the calculation step to be displayed on a screen.

8. The workflow management method according to claim 7, wherein
the calculation step manages tasks included in the critical path as critical tasks and calculates progress of the workflow based on progress of the critical tasks.

9. The workflow management method according to claim 7, wherein,
when a delay is detected in progress of the workflow, the display control step causes the detection of the delay to be displayed on the screen.

10. The workflow management method according to claim 7, further comprising:
a transmission step of transmitting, when a delay is detected in progress of the workflow in the calculation step, the detection of the delay to a user.

11. The workflow management method according to claim 7, wherein
the dependence between the plural tasks represents an order relationship between respective tasks.

12. The workflow management method according to claim 7, further comprising:
a registration step of registering the information on the structures of the plural tasks, the dependence between the plural tasks, the statuses of the plural tasks, and the schedules of the plural tasks; wherein
the calculation step recalculates the critical path when the information on the structures of the plural tasks, the dependence between the plural tasks, the statuses of the plural tasks, and the schedules of the plural tasks are changed.

13. A workflow management program for managing a workflow constituted of plural hierarchically segment tasks to be executed on a computer including a storage device and a calculation processing unit, the program causing the computer to function as:
a storage unit that stores task information;
a calculation unit that acquires the task information from the storage unit and calculates a critical path of the workflow from information on structures of the plural tasks, dependence between the plural tasks, statuses of the plural tasks, and schedules of the plural tasks contained in the task information; and
a display control unit that causes the critical path calculated by the calculation unit to be displayed on a screen.

14. The workflow management program according to claim 13, wherein
the calculation unit manages tasks included in the critical path as critical tasks and calculates progress of the workflow based on progress of the critical tasks.

15. The workflow management program according to claim 13, wherein,
when a delay is detected in progress of the workflow, the display control unit causes the detection of the delay to be displayed on the screen.

16. The workflow management program according to claim 13, causing the computer to further function as:
a transmission unit that, when the calculation unit detects a delay in progress of the workflow, transmits the detection of the delay to a user terminal.

17. The workflow management program according to claim 13, wherein
the dependence between the plural tasks represents an order relationship between respective tasks.

18. The workflow management program according to claim 13, causing the computer to further function as:
a registration unit that registers in the storage unit the information on the structures of the plural tasks, the dependence between the plural tasks, the statuses of the plural tasks, and the schedules of the plural tasks; wherein
the calculation unit recalculates the critical path when the information on the structures of the plural tasks, the dependence between the plural tasks, the statuses of the plural tasks, and the schedules of the plural tasks stored in the storage unit are changed.
